(19) United States
(12) Patent Application Publication
(10) Pub. No.: US 2021/0257690 A1
(43) Pub. Date: Aug. 19, 2021

(54) THERMAL MANAGEMENT MULTILAYER SHEET FOR A BATTERY

(71) Applicant: ROGERS CORPORATION, Chandler, AZ (US)

(72) Inventors: Brett Kilhenny, Mystic, CT (US); Robert C. Daigle, Paradise Valley, AZ (US); Christopher Churchill, Dayville, CT (US)

(21) Appl. No.: 17/178,467

(22) Filed: Feb. 18, 2021

Related U.S. Application Data
(60) Provisional application No. 63/086,269, filed on Oct. 1, 2020.
(60) Provisional application No. 62/977,904, filed on Feb. 18, 2020.
(60) Provisional application No. 62/988,664, filed on Mar. 12, 2020.

(51) Int. Cl. H01M 10/6551; H01M 10/647; H01M 10/617; H01M 10/658; H01M 10/613

(52) U.S. Cl. CPC H01M 10/6551; H01M 10/647; H01M 10/613; H01M 10/658; H01M 10/617

(57) ABSTRACT

An assembly for a battery including a thermal management multilayer sheet disposed on a surface of an electrochemical cell, the thermal management multilayer sheet including a thermally-insulating layer, a first heat-spreading layer disposed on a first side of the thermally-insulating layer, and a second heat-spreading layer disposed on a second side of the thermally-insulating layer.

### CROSS-REFERENCE TO RELATED APPLICATIONS

This application claims priority to and the benefit of U.S. Provisional Application No. 62/977,904 filed on Feb. 18, 2020, U.S. Provisional Application No. 62/988,664 filed on Mar. 12, 2020, and U.S. Provisional Application No. 63/086,269 filed on Oct. 1, 2020, the entire contents of each application being incorporated herein by reference.

### BACKGROUND

This disclosure is directed to a thermal management multilayer sheet for use in batteries, in particular for use in delaying or preventing thermal runaway in lithium-ion batteries. The disclosure is further directed to methods for the manufacture of the thermal management multilayer sheet, assemblies for batteries, and batteries including the thermal management multilayer sheet.

The demand for electrochemical energy storage devices, such as lithium-ion batteries, is ever increasing due to the growth of applications such as electric vehicles and grid energy storage systems, as well as other multi-cell battery applications, such as electric bikes, uninterrupted power battery systems, and lead acid replacement batteries. For large format applications, such as grid storage and electric vehicles, multiple electrochemical cells connected in series and parallel arrays are often used. Once a cell is in thermal runaway mode, the heat produced by the cell can induce a thermal runaway propagation reaction in adjacent cells with the potential to cause a cascading effect that can ignite the entire battery.

While attempts to reduce the flammability of such batteries have been considered, many can have drawbacks. For example, modifying the electrolyte by adding flame retardant additives, or using inherently non-flammable electrolytes have been considered, but these approaches can negatively impact the electrochemical performance of the lithium-ion cell. Other approaches to prevent cascading thermal runaway include incorporating an increased amount of insulation between cells or groups of cells to reduce the amount of thermal heat transfer during a thermal event. However, these approaches can limit the upper bounds of the energy density that can be achieved.

With the increasing demand for batteries with reduced risk of thermal runaway, there is accordingly a need for materials for use in batteries that prevent or delay the spread of heat, energy, or both to surrounding cells.

### BRIEF SUMMARY

Disclosed herein is an assembly for a battery comprising a thermal management multilayer sheet disposed on a surface of an electrochemical cell, the thermal management multilayer sheet comprising a thermally-insulating layer, a first heat-spreading layer disposed on a first side of the thermally-insulating layer, and a second heat-spreading layer disposed on a second side of the thermally-insulating layer.

Batteries including the above-described assembly are also disclosed.

Also disclosed herein is a thermal management multilayer sheet, comprising a first high temperature laminate film adhered to a first side of a compressible thermally-insulating layer; and a second high temperature laminate film adhered to a second opposite side of the compressible thermally-insulating layer, wherein the first high temperature laminate film comprises a first heat-spreading layer disposed on a first side of a first integrity layer, and a first adhesive layer disposed on an opposite second side of the first integrity layer, wherein the first adhesive layer adheres the first high temperature laminate film to the first side of the compressible thermally-insulating layer, and wherein the second high temperature laminate film comprises a second heat-spreading layer disposed on a first side of a second integrity layer, and a second adhesive layer disposed on an opposite second side of the second integrity layer, wherein the second adhesive layer adheres the second high temperature laminate film to the second side of the compressible thermally-insulating layer.

The above described and other features are exemplified by the following figures, detailed description, examples, and claims.

### BRIEF DESCRIPTION OF THE DRAWINGS

The following figures are exemplary aspects, which are provided to illustrate the present disclosure. The Figures that are illustrative of the examples are not intended to limit devices made in accordance with the disclosure to the materials, conditions, or process parameters set forth herein.

FIG. 1 is an illustration of an assembly for a battery of the prior art, including an electrochemical cell and a cooling fin;

FIG. 2 is an illustration of an aspect of a wrapped electrochemical cell;

FIG. 3 is an illustration of an aspect of an assembly for a battery including a wrapped electrochemical cell;

FIG. 4 is a schematic of an aspect of a cooling fin comprising coolant channels;

FIG. 5 is an illustration of an aspect of an assembly for a battery comprising the wrapped electrochemical cell;

FIG. 6 is an illustration of an aspect of a thermal management multilayer sheet;

FIG. 7 is an illustration of an aspect of a thermal management multilayer sheet;

FIG. 8 is an illustration of an aspect of a thermal management multilayer sheet located in between two electrochemical cells;

FIG. 9 is an illustration of an aspect of a thermal management multilayer sheet located between two electrochemical cells;

FIG. 10 is an illustration of an aspect of a thermal management multilayer sheet located in a cell array;

FIG. 11 is an illustration of an aspect of a pouch cell battery;

FIG. 12 is an illustration of an aspect of an assembly for a battery including the thermal management multilayer sheet;

FIG. 13 is a schematic of a flame test apparatus;

FIG. 14 is a graph of temperature (° C.) versus time (minutes (min)) showing the results of flame-testing;

FIG. 15 is a schematic a hot plate test apparatus;

FIG. 16 is a graph of temperature (° C.) versus time (min) showing the results of hot plate-testing; and

FIG. 17 is a graph of temperature (° C.) versus time (min) showing the results of hot plate-testing.

### DETAILED DESCRIPTION

Preventing thermal runaway in batteries that include a plurality of cells is a difficult problem, as cells adjacent to a cell experiencing a thermal runaway can absorb enough energy from the event to cause them to rise above their designed operating temperatures, triggering the adjacent cells to also enter into thermal runaway. This propagation of initiating a thermal runaway event can result in a chain reaction in which storage devices enter into a cascading series of thermal runaways, as the cells transfer heat to adjacent cells.

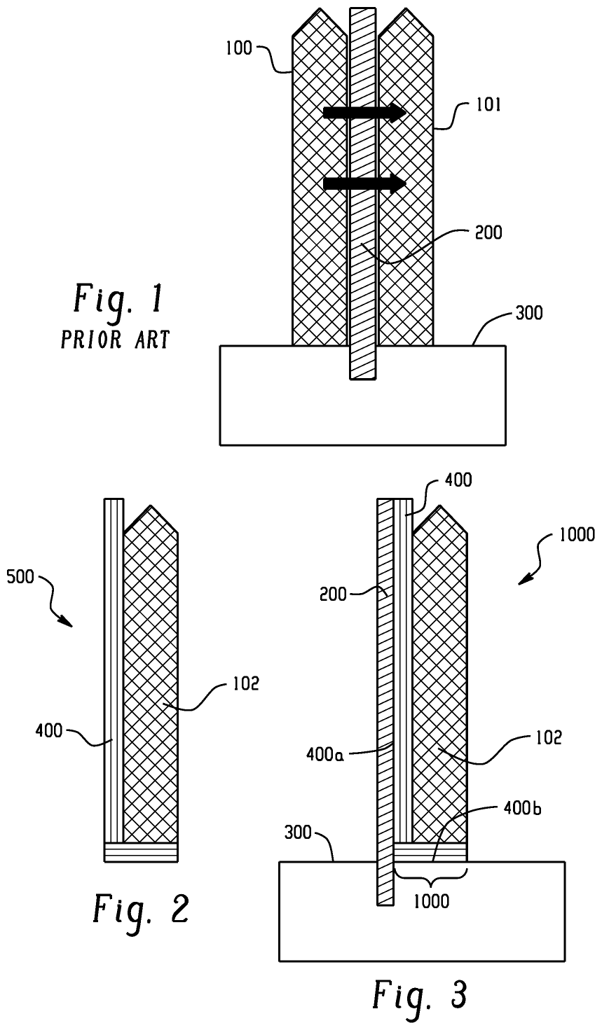

One approach to prevent such cascading thermal runaway events from occurring is to place cooling fins between and preferably in contact with adjacent cells or groups of cells for thermal management during cell operation. In battery designs, the cooling fin can transfer energy from the cell(s) to a cooling plate that runs perpendicular to the cells and cooling fins. However, prior art cooling fins, which are typically made of aluminum, also have a high Z-direction thermal conductivity, which can transfer heat from a cell, e.g., pouch cell, to a neighboring cell. This heat transfer from a cell 100 to a neighboring cell 101 through a prior art aluminum cooling fin 200 in assembly with a cooling plate 300 is illustrated in FIG. 1. Arrows illustrate the Z-direction heat transfer from cell 100 to neighboring cell 101.

In order to prevent cascading thermal runaway events from occurring, a thermal management multilayer sheet can be used in place of, or in addition to a cooling fin, to reduce Z-direction thermal conductivity, and thus reduce heat transfer from a cell to a neighboring cell. The thermal barrier provided by the thermal management multilayer sheet can also be used at various sites in batteries to prevent thermal runaway. Thus, use of the thermal management multilayer sheet can reduce thermal conductivity in any one or more directions. The thermal management multilayer sheet can further improve the fire resistance of batteries.

Accordingly, described herein are assemblies for a battery and batteries that include an electrochemical cell or electrochemical cell array comprising a thermal management multilayer sheet, wherein the thermal management multilayer sheet is disposed directly on a surface (i.e., contacts at least a portion of at least one surface) of an electrochemical cell. As used herein, an electrochemical cell (or “cell”) is the basic unit of a battery including an anode, a cathode, and an electrolyte. A “cell array” means an assembly of two or more electrochemical cells, e.g., two, five, twenty, fifty, or more. The cell or cell array in association with the thermal management multilayer sheet and optionally another battery component, such as a separator, a current collector, a housing such as a flexible pouch, or the like are referred to herein as an “assembly for a battery.” An assembly for a battery and a battery can include a single electrochemical cell, a single cell array, or a plurality of cell arrays.

A variety of electrochemical cell types can be used, including pouch cells, prismatic cells, or cylindrical cells. A single cell or a cell array can be in a flexible enclosure such in a pouch cell. In an aspect, the cells are lithium-ion cells, for example lithium iron phosphate, lithium cobalt oxide, or other lithium metal oxide cells. Other types of cells that can be used include nickel metal hydride, nickel cadmium, nickel zinc, or silver zinc.

In an aspect, an assembly for a battery includes a thermal management multilayer sheet disposed on a surface of an electrochemical cell or a cell array. As illustrated in FIG. 2, a thermal management multilayer sheet 400 can be disposed on at least two surfaces of a cell 102 to provide a wrapped cell 500. The thermal management multilayer sheet includes three or more layers, and is described in detail below. As shown in FIG. 2, the thermal management multilayer sheet 400 is directly on, i.e., directly contacts, at least two, preferably two, surfaces of the cell 102, with no intervening layers. Further as shown in FIG. 2, the thermal management multilayer sheet 400 covers, i.e., is in full contact with, the entirety of at least two, preferably two, surfaces of the cell 102. It is also possible for the thermal management multilayer sheet 400 to be in partial contact with one or more of the surfaces of battery. Thus, the term “wrapped” is used herein for convenience, and does not require full contact between all surfaces of cell 102. In addition, it is to be understood that the thermal management multilayer sheet 400 can be in any configuration suitable for the battery configuration. Thus, the term “sheet” encompasses flat layers as shown, as well as layers that have a profile or that have been shaped, for example by thermoforming. Use of the thermal management multilayer sheet to provide a wrapped cell can reduce thermal conductivity in any one or more directions. In an aspect, the thermal management multilayer sheet reduces Z-direction thermal conductivity, and thus reduce heat transfer from a cell to a neighboring cell.

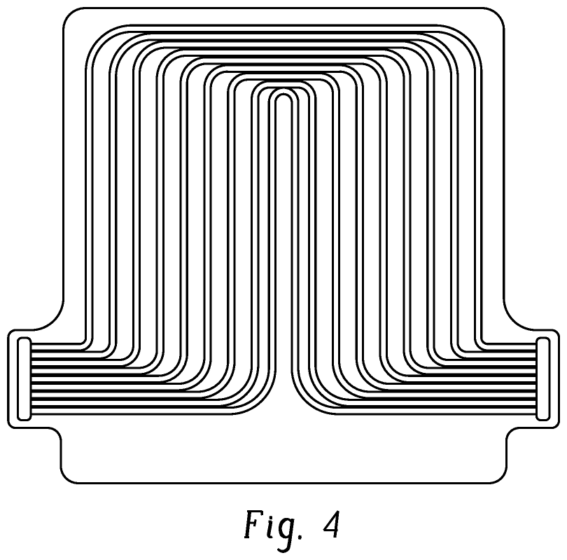

FIG. 3 illustrates an aspect of an assembly 1000 for a battery comprising the wrapped cell 500. The wrapped cell 500 is positioned in the battery such that a first surface 400a of the thermal management multilayer sheet 400 opposite the cell 102 is in thermal contact with a cooling fin 200, and a second surface 400b of the thermal management multilayer sheet 400 opposite the cell 102 is in thermal contact with cooling plate 300.

As illustrated in FIG. 3, cooling fin 200 and wrapped cell 500 are provided in a battery in a Y- or vertical direction relative to the Z-direction shown in FIG. 1. The cooling fin 200 can be disposed so that a broad surface of the cooling fin 200 faces a wrapped surface of the wrapped cell 500. Heat transferred from wrapped cell 500 to the cooling fin 200 can be directly conducted to the cooling plate 300 through the lower end of the cooling fin 200.

Exemplary materials for the cooling plate 300 include aluminum, copper, or alloys thereof. Cooling fins can have an average thickness of 0.0005 inches (12.7 μm) to 0.0200 inches (508 μm), preferably 0.001 inches (25.4 μm) to 0.005 inches (127 μm), and can comprise aluminum or an aluminum alloy, for example. In an aspect, the cooling fin can comprise a plurality of channels so that a coolant can run through the cooling channels. For example, grooves can be stamped onto a first and optionally a second foil sheet or plate, which are then joined, e.g., by a nickel brazing process, to provide the cooling channels. FIG. 4 is a schematic of an exemplary cooling fin comprising coolant channels.

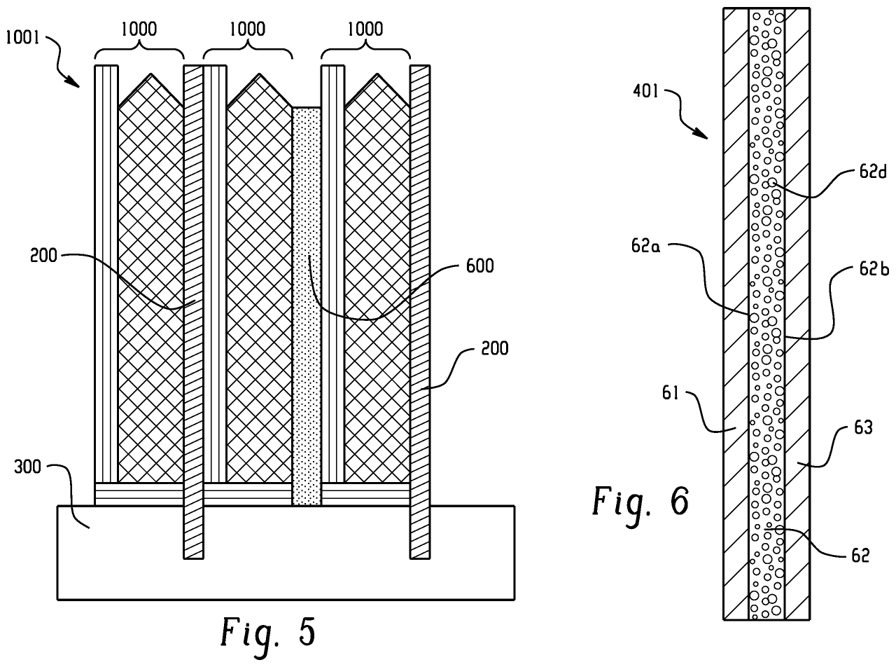

The assembly for a battery can include one or more cells and one or more cooling fins. As shown in FIG. 5, an aspect of an assembly 1001 for a battery comprises a cell array, that is, at least two wrapped cells. The assembly 1001 for a battery further includes a pressure pad 600, also called a compression pad or a battery pad when in a battery, and referred herein as a “pressure pad” for convenience in all instances. The pressure pad 600 disposed between two wrapped cells. The pad can be disposed between adjacent cells as shown in FIG. 5, or between cell arrays to address changes in compression, particularly during cell expansion. The pad can ensure a substantially constant pressure is maintained on the cells.

A cooling fin 200 is disposed on an opposite side of a wrapped cell. Cooling plate 300 is in thermal communication with the cooling fins 200. Additional cooling fins can be present. As stated above, the cells of the cell array can be prismatic cells, pouch cells, cylindrical cells, and the like, and are preferably pouch cells. In an aspect, the cells are lithium-ion cells. In another aspect, the cells are lithium-ion pouch cells.

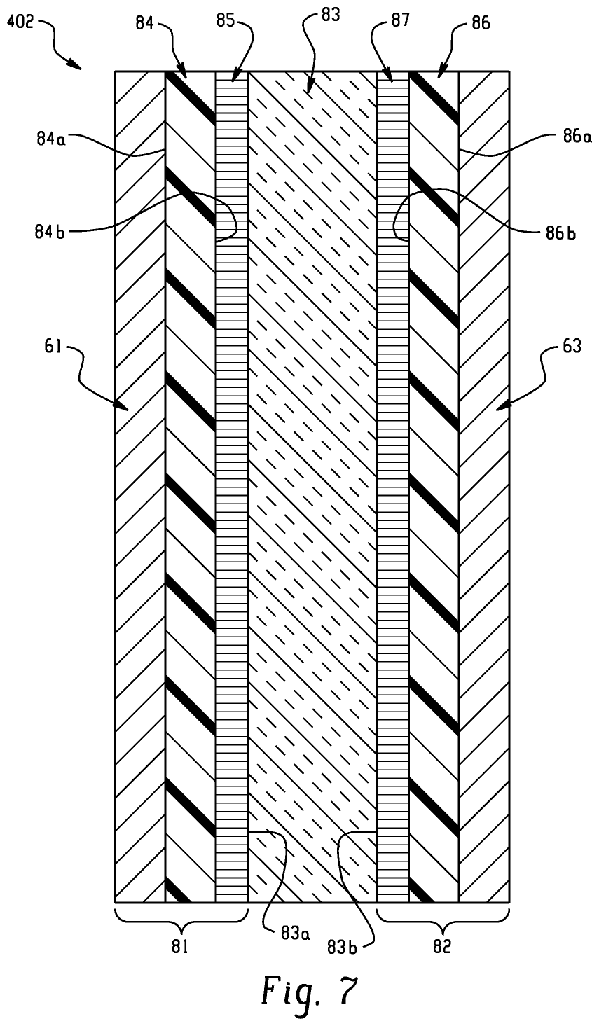

An aspect of the thermal management multilayer sheet is shown in FIG. 6, where a thermal management multilayer sheet 401 comprises a first heat-spreading layer 61 disposed on a first side 62a of a thermally-insulating layer 62. A second heat-spreading layer 63 is disposed on a second side 62b of the thermally-insulating layer 62. Use of two heat-spreading layers can significantly improve the thermal management properties of the multilayer sheets.

The first and second heat-spreading layers 61, 63 each independently comprise a material with high thermal conductivity (Tc), such as greater than 10 Watts per meter-Kelvin (W/m*K), preferably greater than 50 W/m*K, or more preferably greater than 100 W/m*K, each as measured at measured at 23° C. For example, the material can have a thermal conductivity of 10 to 6,000 W/m*K) at 23° C., or 50 to 6,000 W/m*K) at 23° C., or 100 to 6,000 W/m*K), or 100 to 1,000 W/m*K, or 100 to 500 W/m*K, each as measured at 23° C. Such materials include metals such as copper, aluminum, silver, or an alloy of copper, aluminum, or silver; a ceramic such as boron nitride, aluminum nitride, silicon carbide, or beryllium oxide; or a carbonaceous material such as carbon fibers, carbon nanotubes, graphene, or graphite. For example, the heat-spreading layer can be a tape or sheet comprising carbon fibers or carbon nanotubes, such as the those available from Huntsman under the trade name MIRALON. In other aspects the heat-spreading layer is a metal or metal alloy foil, preferably aluminum or an aluminum alloy. In an aspect, the first and second heat-spreading layers are each independently a foil, a woven or nonwoven fiber mat, or a polymer foam.

The thickness of the first and second heat-spreading layers depends on the material used, the degree of thermal conductivity desired, cost, desired thickness, or weight of the battery, or like considerations. For example, the heat-spreading layers can have a thickness of 5 to 1,000 micrometers (μm), such as 0.0005 to 0.039 inches (12.7 to 991 μm), 0.001 to 0.005 inches (25.4 to 127 μm), or 0.002 to 0.039 inches (51 to 991 micrometers). The metal foils can each independently have a thickness of 0.0005 to 0.020 inches (12.7 to 508 μm), or 0.001 to 0.005 inches (25.4 to 127 μm).

The thermally-insulating layer 62 is selected to delay thermal runaway. The thermally-insulating layer 62 can have one or more of a low thermal conductivity, such as 0.01 to 1.0 Watts per meter-Kelvin (W/m*K), preferably 0.01 to 0.09 W/m*K, each measured at 23° C.; a high latent heat of fusion such as 70 to 350 joules per gram (J/g); or both, to delay thermal runaway. The thermally-insulating layer is preferably porous, which can increase the thermal insulation properties. The porosity can vary widely, from 2 to 98% of the total volume of the layer, or from 2 to 50% of the total volume of the layer, or from 5 to 50% of the total volume of the layer, or from 50 to 95% of the total volume of the layer. The pores 62d of the thermally-insulating layer 62 can be open, closed, or a combination thereof. The pores 62d can have a regular shape, irregular shape, or a combination thereof.

The thermally-insulating layer 62 generally comprises a non-metallic material, which as used herein means that material does not comprise solely a metal or metal alloy, such as only aluminum or an aluminum alloy. It is understood however, that some non-metallic materials can contain a metal or metal ion in addition to another constituent. For example, non-metallic materials include mica, which is a mineral composed of silica wherein a portion of the silicon ions can be replaced by aluminum ions. Exemplary materials for use in the thermally-insulating layer includes mica, vermiculite, a zeolite, an aerogel, a polymer foam, polymer fibers, a cork, or a fiberglass. A combination of different materials can be used.

In an aspect, use of a polymer foam, in particular an elastomeric polymer foam in a thermal management multilayer sheet can provide dramatic improvements in reducing thermal conductivity in any one or more directions. In an aspect, such improvements can be provided by especially low thermal conductivity, such as, for example, 0.01 to 0.09 W/m*K, measured at 23° C.; a high latent heat of fusion such as 70 to 350 joules per gram (J/g); or both, as described herein. In an aspect, improvements in reducing thermal conductivity can also be provided by pores in the polymer foam, which can increase the thermal insulation properties, as described herein.

When mica, vermiculite, zeolites, or other particulate materials are used, the layer can comprise a composition including the particulate material and a binder. The binder is selected to maintain the low thermal conductivity, high heat of latent of fusion, or both of the layer described above. The binder can enhance the strength of the particulate layer. Exemplary binders include an epoxy, a phenolic resin, a polyamide, a polyimide, a polyester such as poly(butylene terephthalate), a polyethylene, a polypropylene, a polystyrene, a polycarbonate, a polysulfone, a polyurethane, a silicone, or the like. An epoxy resin, a silicone resin, a phenolic resin, or other thermosetting resin is preferred to bind or enhance the strength of the particulate layer. The amount of binder is selected so as to achieve optimal thermal conductivity and mechanical properties (e.g., high strength). For example, the composition can comprise 20 to 90 weight percent (wt %) of the particulate filler and 10 to 80 wt % of the binder, or 20 to 80 wt % of the particulate filler and 20 to 80 wt % of the binder, each based on the total weight of the composition and totaling 100 wt %.

An aerogel is an open-celled solid matrix comprising a network of interconnected nanostructures with a porosity of greater than 50 volume percent (vol %), more preferably greater than 90 vol %. Aerogels can be derived from a gel by replacing the liquid component in the gel with a gas, or by drying a wet gel, such as by supercritical drying. Exemplary aerogels include polymer aerogels, including poly(vinyl alcohol), urethane, polyimide, or polyacrylamide aerogels; polysaccharide aerogels including chitin and chitosan aerogels; or inorganic ceramic aerogels such as aluminum oxide or silica aerogels.

The polymer fibers or foams can include one or more of a wide variety of thermoplastics, blends of thermoplastics, or thermosetting resins. Examples of thermoplastics that can be used include polyacetals, polyacrylics, polyamides such as Nylon 6, Nylon 6,6, Nylon 6,10, Nylon 6,12, Nylon 11 or Nylon 12, polyamideimides, polyarylates, polycarbonates, polystyrenes, polyesters such as polyethylene terephthalate (PET), polybutylene terephthalate (PBT) and polyethylene naphthalate (PEN), polyetherketones, polyether etherketones, polyether ketone ketones, polyetherimides, polyolefins such as polypropylene, polyethylene, or copolymers of polyethylene or polypropylene, polyphenylene sulfides, polystyrene, polysulfones such as polyarylsulfones and polyethersulfones, polyurethanes, polyvinyl chlorides, fluorinated polymers such as polychlorotrifluoroethylenes, polyvinylidene fluorides (PVDF), polyvinyl fluorides, polytetrafluoroethylenes, perfluoromethyl vinylethers, fluorinated polyethylene-propylene (FEP), or tetrafluoroethylene-vinylidene fluoride-hexafluoropropylene (HFP), ethylene propylene rubbers (EPR), ethylene propylene diene monomer rubbers (EPDM), styrene-acrylonitrile (SAN), styrene-maleic anhydride (SMA), acrylonitrile-butadiene-styrene (ABS), a natural rubber, a nitrile rubber, butyl rubber, a cyclic olefin copolymer, polydicyclopentadiene rubber, styrene-ethylene/propylene-styrene block copolymer (SEPS), a styrene-butadiene block copolymer (SB), a styrene-butadiene-styrene) copolymer (SBS), a styrene-ethylene/butylene-styrene block copolymer (SEBS), a polybutadiene, an isoprene, a polybutadiene-isoprene copolymer, or the like, or a combination thereof.

Examples of blends of thermoplastic polymers that can be used in the polymer fibers or foams include ABS/nylon, polycarbonate/ABS, ABS/polyvinyl chloride, polyphenylene ether/polystyrene, polyphenylene ether/nylon, polysulfone/ABS, polycarbonate/thermoplastic urethane, polycarbonate/PET, polycarbonate/PBT, thermoplastic elastomer alloys, PET/PBT, SMA/ABS, polyether etherketone/polyethersulfone, styrene-butadiene rubber, polyethylene/nylon, polyethylene/polyacetal, or the like, or a combination thereof.

Examples of thermosetting resins that can be used in the polymer fibers or foams include polyurethanes, epoxies, phenolics, polyesters, polyamides, silicones, and the like, or a combination thereof. Blends of thermosetting resins as well as blends of thermoplastic resins with thermosetting resins can be used.

Preferred polymer fibers or foams that can be used in the thermally-insulating layer include an epoxy, a polyamide, a polyimide, a polyester such as PBT, a polyethylene, a polypropylene, a polystyrene, a polycarbonate, a polysulfone, a polyurethane, a silicone, a vinylester, or the like, or a combination thereof. In an aspect the polymer fiber comprises a heat resistant polymer, e.g., a polymer having a Tg of 180° C. or higher, such as a polyetherimide, a polysulfone, a polyphthalamide, a polyphenylene sulfide, a polyarylate, a polyether ether ketone, or the like, or a combination thereof. The polymer fibers can be in the form of woven or nonwoven mats or tapes. Polyurethane or silicone foams, in particular compressible polyurethane or silicone foams are preferred and are described in more detail below. The polymer foams or fibers can include other additives as is known in the art, for example a processing aid, a flame retardant, a filler, an antioxidant, an antiozonant, an ultraviolet (UV) or heat stabilizer, or a combination thereof. The fillers can be selected to provide additional thermal insulation, heat absorption or heat deflection properties. Exemplary fillers include ceramics such as silica, talc, calcium carbonate, clay, mica, vermiculite, or the like, or a combination thereof.

Cork materials that can be used in the thermally-insulating layer include both natural and artificial cork.

Exemplary fiberglass layers comprise A-glass, C-glass, D-glass, or a combination thereof. D-glass or E-glass is preferred. The fiberglass layer can dispose in a polymer matrix or coated with a polymer. An epoxy, a polyamide, a polyimide, a polyester such as poly(butylene terephthalate), a polyethylene, a polypropylene, a polystyrene, a polycarbonate, a polysulfone, a polyurethane, a silicone, a vinyl ester, or the like can be used. Preferred binders include epoxies, polyesters, and vinylesters.

The thickness of thermally-insulating layer 62 can depend on the material used, the degree of thermal conductivity desired, cost, desired thickness or weight of the battery, or like considerations. For example, the thermally-insulating layer 62 can have a thickness of 50 to 15,000 μm, for example 50 to 5,000, or 50 to 4,000 μm, or 0.002 to 0.118 inches (51 to 2,997 μm), preferably 0.006 to 0.020 inches (152 to 508 μm). In an aspect, the thermally-insulating layer can include mica, a zeolite, polymer fibers, or a fiberglass and have a thickness of 50 to 5,000 μm. In another aspect the thermally-insulating layer can include a polymer foam, and have a thickness of 250 to 10,000 μm, or 500 to 10,000 μm.

The first, second, or both heat-spreading layers and the thermally-insulating layer can be disposed directly on each other, or disposed on each other and adhered using one or more layers of an adhesive. When an adhesive layer is used, the adhesive layer can have a thickness of 0.00025 to 0.010 inches (6 to 254 μm), or 0.0005 to 0.003 inches (12.7 to 76 μm). A wide variety of adhesives are known in the art and can be used. For example, the adhesive layers can each independently comprise a polyester adhesive, a polyvinyl fluoride adhesive, an acrylic or methacrylic adhesive, or a silicone adhesive. In an aspect, the adhesive is a silicone adhesive. Solvent-cast, hot-melt, and two-part adhesives can be used. In an aspect, each adhesive layer can independently comprise an inorganic filler that can be heat-spreading or thermally-insulating.

Optionally, each of the adhesive layers can independently include a filler that can be heat-spreading (thermally conducting) or thermally insulating. Exemplary fillers include aerogel fillers, glass microballoons, gas-filled hollow polymer microspheres, boron nitride, aluminum nitride, mica, talc, carbon nanotubes, graphite, or a combination thereof. The additives can be surface coated to provide desired characteristics, for example the fillers can be treated with a silane to improve dispersion or adhesion. For example, each adhesive layer can include a high aspect ratio platy filler such as mica or talc. In an aspect, no filler is present.

When the thermally-insulating layer is not compressible, or does not have reliable or sufficient compression-set values, it can be advantageous to use a pressure pad in conjunction with the thermal management multilayer, as shown in FIG. 5. Of course, the pressure pad can be located at other positions within the battery. In an aspect, a pressure pad can have a thickness of 0.010 to 0.500 inches (254 to 12,700 μm) and comprises a compressible material that has a reliable consistent compression set resistance (c-set) and stress relaxation performance over a broad range of temperatures. Exemplary materials of this type include a polyurethane or silicone foams (such as a PORON® polyurethane foam or a BISCO® silicone foam available from Rogers Corporation). Other compressible materials that can be used as the pressure pad are those described herein.

In another aspect, FIG. 7 illustrates a thermal management multilayer sheet 402 including a compressible thermally-insulating layer 83. Multilayer sheet 402 further includes a first and a second high temperature laminate 81, 82. Each of the first and the second high temperature laminate 81, 82 is disposed on a first side 83a and an opposite second side 83b, respectively, of compressible thermally-insulating layer 83. As used herein, “compressible” refers to an elastomeric property whereby the material compresses under pressure, and returns to its original state upon release of pressure.

The compressible thermally-insulating layer can be selected to have properties that provide pressure management to a battery and that allow it to replace or supplement a pad as described above. In particular the compressible thermally-insulating layer is selected to provide one or more of a reliable and consistent c-set resistance and stress relaxation performance over a broad range of temperatures, e.g., −15 to 120° C. The compressible thermally-insulating layer can have a compression set at 158° F. (70° C.) of less than 10%, preferably less than 5%, measured according to ASTM D 3574-95 Test D. In some aspects, the compressible thermally-insulating layer can have a force retention of greater than 50%, measured for 168 hours, at 70° F. (21° C.) in accordance with ISO 3384. The compressible thermally-insulating layer can have a thickness effective to provide the desired pressure management. For example, the compressible thermally-insulating layer can have an uncompressed thickness 250 to 15,000 μm, or 0.020 to 0.500 inches (508 to 12,700 μm), or 0.040 to 0.157 inches (1,016 to 3,988 μm).

In an aspect, the thermally-insulating layer 62 (FIG. 5) or compressible thermally-insulating layer 83 (FIG. 7) is a compressible material such as an elastomer or the above-described rubbers, in particular vinyl acetate (EVA), a thermoplastic elastomer (TPE), EPR, or EPDM; or a polymer foam.

In an aspect the compressible thermally-insulating layer is a compressible polymer foam. As used herein, a “foam” refers to a material having a porous (i.e., a cellular) structure. Exemplary compressible foams have densities lower than 65 pounds per cubic foot (pcf) (1,041 kilograms per cubic meter (kg/m³)), preferably less than or equal to 55 pcf (881 kg/m³), or preferably not more than 25 pcf (400 kg/m³). The compressible polymer foam can have a void volume content of at least 5 to 99%, preferably greater than or equal to 30%, based upon the total volume of the foam.

The polymer materials described above can be used as the compressible polymer foam. An optional additive can be present in the composition for the manufacture of the compressible polymer foam, as described above in connection with the polymer fibers and foams. In an aspect, the compressible polymer foam has a density of 5 to 30 pounds per cubic foot (lb/ft³) (80 to 481 kg/m³), a 25% compression force deflection (CFD) of 0.5 to 100 lb/in² (351.5 to 70,307 kilograms per square meter (kg/m²)), measured according to ASTM D 3574-95 Test C, and a compression set at 158° F. (70° C.) of less than 10%, preferably less than 5%, measured according to ASTM D 3574-95 Test D. Preferably the compressible polymer foam is a polyurethane or silicone foam having the foregoing properties.

In an aspect, the compressible polymer foam is an open cell, low modulus polyurethane foam that can have an average cell size of 50 to 250 μm, as can be measured, for example, in accordance with ASTM D 3574-95; a density of 5 to 50 lb/ft³ (80 to 800.9 kg/m³), preferably 6 to 25 lb/ft³ (96 to 400 kg/m³), a compression set at 158° F. (70° C.) of less than 10%, measured according to ASTM D 3574-95 Test D, and a force-deflection of between 1-250 pounds per square inch (psi) (7 to 1724 kiloPascals (kPa). Compressible polyurethane foams can be manufactured from compositions known in the art. Suitable compressible polyurethane foams are marketed under the name PORON® 4700 by the Rogers Corporation, Woodstock, Conn., for example PORON® EVExtend 4701-43RL. These compressible polyurethane foams can be formulated to provide an excellent range of properties, including compression set resistance. Foams with good compression set resistance provide cushioning, and maintain their original shape or thickness under loads for extended periods.

In another aspect, the compressible polymer foam is a silicone foam comprising a polysiloxane. In an aspect, the silicone foams are produced as a result of the reaction between water and hydride groups in a polysiloxane polymer precursor composition with the consequent liberation of hydrogen gas. This reaction is generally catalyzed by a noble metal, preferably a platinum catalyst. The catalyst can be deposited onto an inert carrier, such as silica gel, alumina, or carbon black. Various platinum catalyst inhibitors can also be used to control the kinetics of the blowing and curing reactions in order to control the porosity and density of the silicone foams. Examples of such inhibitors include polymethylvinylsiloxane cyclic compounds and acetylenic alcohols. These inhibitors should not interfere with the foaming and curing in such a manner that destroys the foam.

In an aspect, the polysiloxane polymer has a viscosity of 100 to 1,000,000 poise at 25° C. and has chain substituents such as hydride, methyl, ethyl, propyl, vinyl, phenyl, and trifluoropropyl. The end groups on the polysiloxane polymer can be hydride, hydroxyl, vinyl, vinyl diorganosiloxy, alkoxy, acyloxy, allyl, oxime, aminoxy, isopropenoxy, epoxy, mercapto groups, or other known, reactive end groups. Silicone foams can also be produced by using several polysiloxane polymers, each having different molecular weights (e.g., bimodal or trimodal molecular weight distributions) as long as the viscosity of the combination lies within the above specified values. It is also possible to have several polysiloxane base polymers with different functional or reactive groups in order to produce the desired foam. In an aspect, the polysiloxane polymer comprises 0.2 moles of hydride (Si—H) groups per mole of water.

Methods for the manufacture of compressible polymer foams are generally known. The foams can be mechanically frothed, physically or chemically blown, or both. The polyurethane foams can be made by casting a mechanically frothed composition. In particular, the reactive precursors of the polyurethane can be mixed and mechanically, frothed, then cast to form a layer, and cured. In the production of silicone foams, the reactive components of the precursor composition are stored in two packages, one containing the platinum catalyst and the other the polysiloxane polymer containing hydride groups, which prevents premature reaction. In another method of production, the polysiloxane polymer is introduced into an extruder along with the electrically conductive particles, water, physical blowing agents if necessary, and other desirable additives. The platinum catalyst is then metered into the extruder to start the foaming and curing reaction. The use of physical blowing agents such as liquid carbon dioxide or supercritical carbon dioxide in conjunction with chemical blowing agents such as water can give rise to foam having much lower densities. In yet another method, the liquid silicone components are metered, mixed, and dispensed into a device such a mold or a continuous coating line. The foaming then occurs either in the mold or on the continuous coating line.

The compressible thermally-insulating layer can include a reinforcement material to reinforce the strength thereof. The reinforcement material for the thermally-insulating layer can be fibrous, for example continuous fibers in the form of a woven or nonwoven fiber mat that can have a thickness of 20 to 600 μm, or of 0.001 to 0.020 inches (25.4 to 508 μm), preferably 0.001 to 0.005 inches (25.4 to 127 μm). The reinforcement material for the thermally-insulating layer can comprise a high heat resistance woven or nonwoven polymer fiber mat, e.g., a polyetherimide, a polysulfone, a polyphthalamide, a polyphenylene sulfide, a polyarylate, a polyether ether ketone, or the like; or a woven nonwoven glass fiber mat, such as a fiberglass as described above. In an aspect, reinforcement material for the thermally-insulating layer comprises a plain weave 1080 E-glass.

Referring again to FIG. 7, the first high temperature laminate 81 comprises a first heat-spreading layer 61 disposed on a first side 84a of a first integrity layer 84. A second side 84b of the first integrity layer 84 is disposed on a first adhesive layer 85. First adhesive layer 85 adheres the first integrity layer 84 to the first side 83a of the compressible thermally-insulating layer 83. The second high temperature laminate film 82 comprises a second heat-spreading layer 63 disposed on a first side 86a of a second integrity layer 86. A second side 86b of the second integrity layer 86 is disposed on a second adhesive layer 87, which adheres the second integrity layer 86 to the second side 83b of the compressible thermally-insulating layer 83.

The first and second heat-spreading layers 61, 63 can be the same or different, and are as described herein.

The first and second integrity layers 84, 86 are a reinforcement material to reinforce the strength of the thermal management multilayer. Each can independently include continuous fibers, for example, in the form of a woven or nonwoven fibrous mat that can have a thickness of 20 to 600 μm, or of 0.001 to 0.020 inches (25.4 to 508 μm), preferably 0.001 to 0.005 inches (25.4 to 127 μm). The first and second integrity layers can comprise a high heat resistance woven or nonwoven polymer mat, e.g., a polyetherimide, a polysulfone, a polyphthalamide, a polyphenylene sulfide, a polyarylate, a polyether ether ketone, or the like; or a woven nonwoven glass mat, such as a fiberglass as described above. In an aspect, each first and second integrity layers comprise a plain weave 1080 E-glass.

The first and second adhesive layers can have any thickness suitable to provide effective adhesion, preferably wherein the thickness is also adjusted to not waste adhesive material or significantly adversely affect the desired properties of the thermal management multilayer sheet. For example, the first and second adhesive layers can have a thickness of 0.00025 to 0.010 inches (6.35 to 254 μm), or 0.0005 to 0.003 inches (12.7 to 76.2 μm). The first and second adhesive layers 85, 87 can be the same or different, and are as described herein. For example, the first and second adhesive layers can each independently comprise a polyester adhesive, a polyvinyl fluoride adhesive, an acrylic or methacrylic adhesive, or a silicone adhesive. In an aspect, the adhesive is a silicone adhesive. Also as described above, each adhesive layer can independently comprise an inorganic filler that can be heat-spreading or thermally insulating. For example, the adhesive can include a high aspect ratio platy filler such as mica or talc. In an aspect, no filler is present.

The thermal management multilayer and subcombinations in the thermal management multilayer (e.g., the high temperature laminate) can be manufactured by methods known in the art depending on the materials used for the heat-spreading, thermally-insulating, and optional adhesive layers. Manufacture can be, for example, by stacking the layers individually and laminating, with or without an adhesive; by coating or casting a composition for a heat-spreading layer onto a thermally-insulating layer; by dipping a thermally-insulating layer into a composition for forming the heat spreading layer; or by coating or casting a composition for forming the thermally-insulating layer directly onto a heat-spreading layer or onto an adhesive layer disposed on a heat-spreading layer. Processes such as roll over roll, knife over roll, reverse roll, slot die, or gravure coating can be used. In an aspect, when the thermally-insulating layer comprises a polymer foam, the foam-forming composition can be cast onto a first heat-spreading layer such as a metal foil, foamed and covered with a second foil layer to control the thickness of the foam, and then heated to cure the foam. An adhesive layer can be present on one or both of the foil layers. Alternatively, or in addition, a subcombination such as the thermally-insulating layer or the high temperature laminate can be obtained commercially and then assembled with one or more additional layers to form the thermal management multilayer. An example of a commercially available high temperature laminate is a plasma tape, e.g., an aluminum foil/glass fabric laminate further comprising a high temperature silicone adhesive disposed on the glass fabric. Such laminates are commercially available from DeWAL under the trade name DW series plasma tapes, such as the DW 407 plasma tape.

It is to be understood that the aspects shown in FIG. 6 and FIG. 7 are exemplary only, and that various combinations and subcombinations can be used depending on the desired properties. For example, a thermal management multilayer sheet as shown in FIG. 7 can include only a single integrity layer. Additional heat-spreading, adhesive, or thermally-insulating layers can be present. For example, a thermal management multilayer sheet as shown in FIG. 6 can include an additional thermally-insulating layer on a side of a heat-spreading layer, with or without an additional adhesive layer therebetween.

Still other layers or components that can be present in the thermal management multilayer sheet include a phase-change material. Specifically, the thermally-insulating layer can include a phase-change material. Alternatively, or in addition a layer comprising a phase change material can be disposed on the thermally-insulating layer. A phase-change material is a substance with a high heat of fusion and that is capable of absorbing and releasing high amounts of latent heat during a phase transition, such as melting and solidification, respectively. During the phase change, the temperature of the phase-change material remains nearly constant. The phase-change material inhibits or stops the flow of thermal energy through the material during the time the phase-change material is absorbing or releasing heat, typically during the material's change of phase. In some instances, a phase-change material can inhibit heat transfer during a period of time when the phase-change material is absorbing or releasing heat, typically as the phase-change material undergoes a transition between two states. This action is typically transient and will occur until a latent heat of the phase-change material is absorbed or released during a heating or cooling process. Heat can be stored or removed from a phase-change material, and the phase-change material typically can be effectively recharged by a source of heat or cold.

Suitable phase change materials are described, for example, in WO2020/227201. As described therein, the phase change materials can be encapsulated or unencapsulated, or a combination can be used. The phase change materials can be used in a composition further comprising a polymer as described above. The polymer can comprise one o or a combination as described above, for example polyvinyl chloride, polystyrene, polyether sulfone, ABS, SAN, PEN, PBT, PET, PVDF, perfluoromethylvinylether, polypropylene, polyethylene, copolymers of polyethylene or polypropylene, polytetrafluoroethylene (PTFE), FEP, vinylidene fluoride, HFP, EPR, EPDM, a natural rubber, a nitrile rubber, butyl rubber, a cyclic olefin copolymer, polydicyclopentadiene rubber, a thermoplastic polyurethane, SEPS, poly(styrene-butadiene-styrene) (SBS), SEBS, a polybutadiene, an isoprene, a polybutadiene-isoprene copolymer, or a combination thereof. The amount of the phase-change material can be 20 to 98 wt %, or 40 to 97 wt %, or 50 to 96 wt %, or 50 to 95 wt %, or 40 to 95 wt %, or 50 to 90 wt %, or 60 to 85 wt %, or 75 to 85 wt %, based on the total weight of the phase-change composition.

In an aspect, the thermally-insulating layer can include an intumescent composition, or the thermal management multilayer sheet can comprise a layer comprising an intumescent composition. The layer can be disposed on the heat-spreading layer opposite the thermally-insulating layer, or between the heat-spreading layer and the thermally-insulating layer. Without being bound by theory, it is believed that the intumescent material can reduce the spread of flames using two energy absorbing mechanisms, including forming a char and then swelling the char. For example, as the temperature reaches a value, for example, of 200 to 280° C., the acidic species (for example, of the polyphosphate acid) can react with the carbon source (for example, pentaerythritol) to form a char. As the temperature increases, for example, to 280 to 350° C., the blowing agent can then decompose to yield gaseous products that cause the char to swell. Intumescent materials are known, being described, for example, in WO2020/251825. The intumescent material can comprise an acid source, a blowing agent, and a carbon source. Each of these components can be present in separate layers or as an admixture, preferably an intimate admixture. For example, the intumescent material can comprise a polyphosphate acid source such as tris(2,3-dibromopropyl)phosphate, tris(2-chloroethyl)phosphate, tris(2,3-dichloropropyl)phosphate, tris(1-chloro-3-bromoisopropyl) phosphate, bis(1-chloro-3-bromoisopropyl)-1-chloro-3-bromoisopropyl phosphonate, polyaminotriazine phosphate, melamine phosphate, guanylurea phosphate, or a combination thereof, a carbon source such as dextrin, a phenol-formaldehyde resin, pentaerythritol, a clay, a polymer, or a combination thereof; and a blowing agent such dicyandiamide, an azodicarbonamide, a melamine, a guanidine, a glycine, a urea, a halogenated organic material, or a combination thereof.

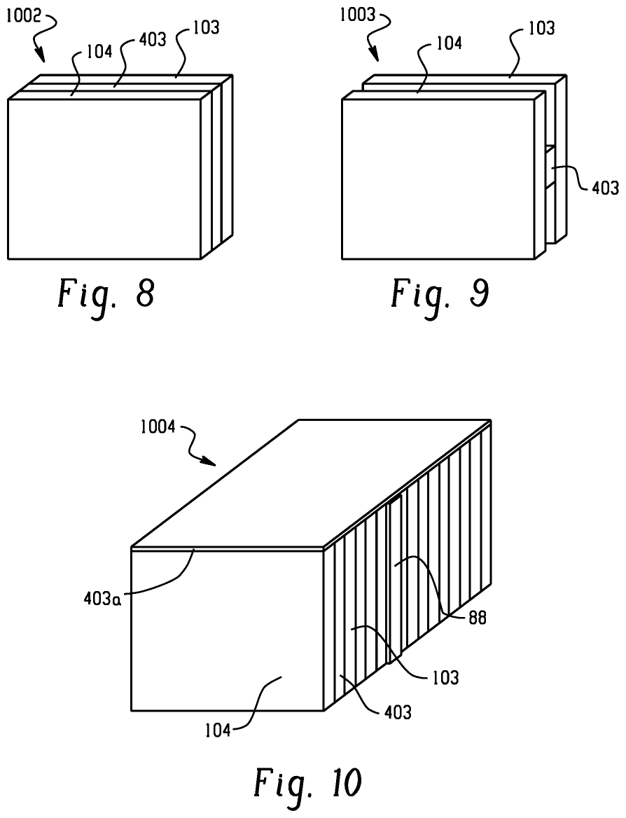

The thermal management multilayer sheet is disposed on an electrochemical cell, e.g., at least a portion of at least one electrochemical cell to provide a cell assembly for a battery. For example, FIG. 8 illustrates an aspect of the positioning of the thermal management multilayer sheet in an assembly 1002 for a battery and FIG. 9 illustrates an aspect of the positioning of the thermal management multilayer sheet in an assembly 1003 for a battery. The cells can be lithium-ion cells, in particular, pouch cells. FIG. 8 and FIG. 9 illustrate that the thermal management multilayer sheet 403 can be located between a first cell 103 and a second cell 104. FIG. 8 illustrates that the thermal management multilayer sheet 403 can be approximately the same size as the height and width of the cells 103, 104. FIG. 9 illustrates that the thermal management multilayer sheet 403 can be smaller than the respective cells 103, 104. As shown in FIG. 5 it is also possible for the thermal management multilayer sheet to extend past an edge of an electrochemical cell in order to cover at least a portion or all of a surface of the cell.

FIG. 10 illustrates that an assembly 1004 for a battery can comprise more than two cells (e.g., 103, 104) with thermal management multilayer sheet 403 located in between the respective cells 103, 104 and each of the other cells. In an aspect, two to ten fire-resistant thermal management multilayer sheets can be disposed on a cell or in a cell array during manufacture of the assembly 1004 for a battery. For example, two to ten thermal management multilayer sheets can be disposed on the interior, e.g., facing the electrodes, or exterior, facing outside of the battery. For example, two to ten fire-resistant thermal management multilayer sheets can be disposed on or adhered to a cell or pouch of a pouch cell, or both. Of course, one or more than ten of the thermal management multilayer sheets can be present depending on the number of cells and cell arrays. FIG. 10 further illustrates thermal management multilayer sheet 403a disposed on an exterior of assembly 1004 for a battery, to face outside of a battery.

In an aspect, at least a portion of the exposed outer edges of the thermal management multilayer sheet can comprise a material 88 that pulls heat away from the body of the thermal management multilayer sheet. Exemplary materials to apply to the exposed edges of the thermal management multilayer sheet include ceramics such as boron nitride or aluminum nitride, a metal such as aluminum, a high heat capacity wax, a phase change material, or the like, or a combination thereof.

The cell assemblies are used in batteries. A battery includes a housing that at least partially encloses one or more electrochemical cells or cell arrays. As shown in FIG. 11, an exemplary battery 2000 can include a flexible housing, e.g., a pouch, 51 that surrounds and seals an electrode assembly 52. The enclosure for pouch cells or the battery of FIG. 11 is generally a laminate material including a metal foil layer. For example, a laminate pouch cell material can include a metal foil, such as an aluminum foil, between two polymer layers. The metal foil is intended to function as a barrier against all permeation, both into and out from the battery cell, including water diffusion. The laminate therefore completely encloses the electrochemical cell or cell array, sealing the cell or cell array. The thermal management multilayer sheet is additional to the housing, i.e., the pouch 51.

The electrode assembly 52 can include an anode, a separator, a cathode, and an electrolyte. The battery 2000 also includes a negative current collector 53 connected to an anode and a positive current collector 54 connected to a cathode. The negative current collector 53 and the positive current collector 54 can be electrically connected to a control electronic system 55 that includes the control electronics for the battery. The battery 2000 also includes a negative outside lead 56 and a positive outside lead 57 that enable connection of the battery 2000 to a circuit or device.

The thermal management multilayer sheet can be disposed on, or disposed directly on a cell or cell array in any configuration in a battery. The thermal management multilayer sheet can be placed between individual cells or cell arrays in the battery. The thermal management multilayer sheet can be placed on, e.g., at the top, in between, below, adjacent, or a combination thereof the sides of the cells or cell arrays in the battery, a portion thereof, or a selected set of cells or cell arrays in the battery. The thermal management multilayer sheet, for example, with no exposed adhesive, can be placed or adhered to a plurality of pouch cells, pressure management pads, cooling plates, or other interior battery components. The assembly pressure of the battery can hold stacked components into place.

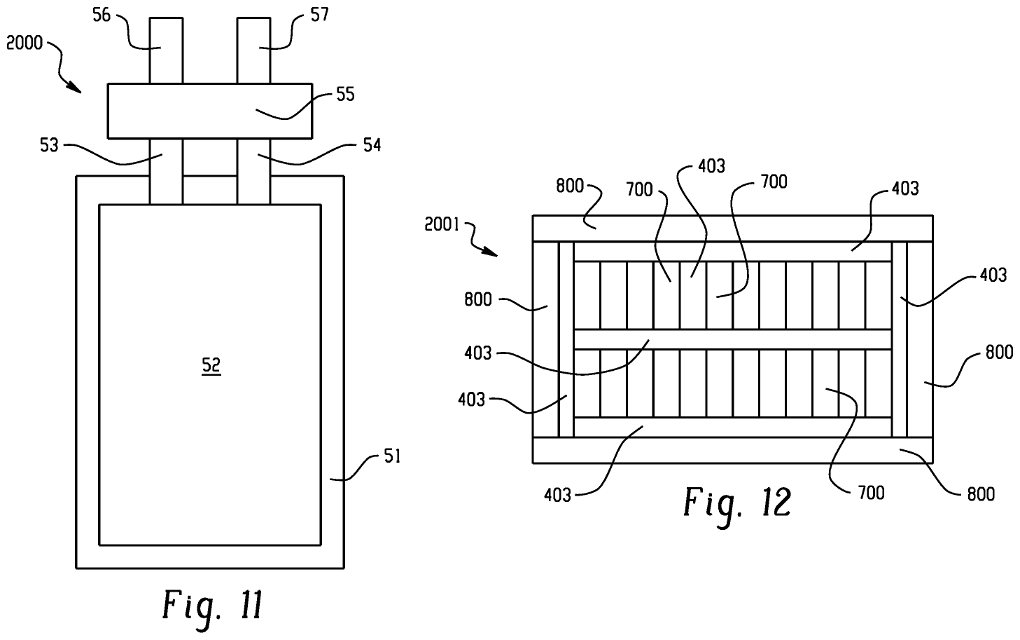

For example, as shown in FIG. 12, a battery 2001 can contain a plurality cells in a plurality of cell arrays 700 inside a housing 800. The thermal management multilayer sheet 403 can be disposed between two cell arrays 700. Further as shown in FIG. 12, the thermal management multilayer sheet 403 can be disposed between a side of housing 800 and a side of a cell array 700, along a plurality of the cells of the cell array. Also as shown in FIG. 12, the thermal management multilayer sheet 403 can be disposed between an end of housing 800 and an end of one or more cell arrays 700.

The following examples are provided to illustrate the present disclosure. The examples are merely illustrative and are not intended to limit devices made in accordance with the disclosure to the materials, conditions, or process parameters set forth therein.

### EXAMPLES

The materials listed in Table 1 were used in the examples.

TABLE 1

| Component | Description | Tradename | Manufacturer |
|---|---|---|---|
| Polyurethane | Polyurethane foam; density 192 kg/m³ measured according to | PORON ™ | Rogers |
| foam sheet | ASTM D 3574-95, Test A; thickness 1-3 mm; CFD 41-83 kPa | EVExtend | Corporation |
| | measured with 0.51 cm/minute strain rate and force measured | 4701-43RL | |
| | at 25% deflection; compression set 5% max. measured | | |
| | according to ASTM D 3574-95 Test D at 70° C. | | |
| Plasma | Flexible aluminum foil backed with a glass cloth; thickness | ProCell ™ | Rogers |
| tape 1 | 0.180 ± 0.028 mm; silicone adhesive system; adhesion 480- | 800 EV | Corporation |
| | 893 g/cm measured according to ASTM-D 1000; density 1.41 | Firewall | |
| | g/cm³; thermal conductivity 1.36 W/m*K measured according | | |
| | to ASTM-C 518 @ 23° C.; heat capacity 1.1 J/g*C. measured | | |
| | according to ASTM-E 1269 | | |
| Plasma | Flexible aluminum foil backed with a glass cloth; aluminum | ProCell ™ | Rogers |
| tape 2 | foil/glass fabric backing thickness 0.076-0.106 mm; acrylic | 801 EV | Corporation |
| | adhesive; adhesive thickness 0.076-0.102 mm; adhesion 603- | Firewall | |
| | 804 g/cm measured according to ASTM-D 1000; density 1.4 | | |
| | g/cm³; thermal conductivity 1.36 W/m*K measured according | | |
| | to ASTM-C 518 @ 23° C.; heat capacity 1.1 J/g*C. measured | | |
| | according to ASTM-E 1269 | | |
| Plasma | Blue silicone rubber-coated glass fabric with a high | DeWAL ™ | Rogers |
| tape 3 | temperature silicone adhesive; silicone/glass cloth backing | DW410 | Corporation |
| | thickness 0.178-0.229 mm; silicone adhesive; adhesive | | |
| | thickness 0.064-0.089 mm; adhesion 335-670 g/cm measured | | |
| | according to ASTM-D 1000 | | |
| Silicone | Ultra Soft flame retardant silicone foam; thickness 3.18-12.70 | BISCO ™ | Rogers |
| foam | mm; density 160-240 kg/m³ based on BF2000 data sheet; | BF-2000 | Corporation |
| | Compression Force Deflection 0-17 kPa measured according | | |
| | to ASTM D1056; compression set <12% measured according | | |
| | to ASTM D1056 at 100° C./22 hours/50% | | |

Samples were formed by adhering plasma tape to opposite sides of a polyurethane foam sheet using a weighted roller in the lab. The samples were placed adjacent to a 12.7 millimeter (mm) thick pouch cell analog and subjected to burn testing or hot plate-testing.

### COMPARATIVE EXAMPLE

A polyurethane foam sheet only was used.

### Example 1

A thermal management multilayer sheet included plasma tape 1 on both sides of the polyurethane foam sheet.

### Example 2

A thermal management multilayer sheet included plasma tape 2 on both sides of the polyurethane foam sheet.

### Example 3

A thermal management multilayer sheet included plasma tape 3 on both sides of the polyurethane foam sheet.

### Example 4

A thermal management multilayer sheet included plasma tape 1 on both sides of the silicone foam.

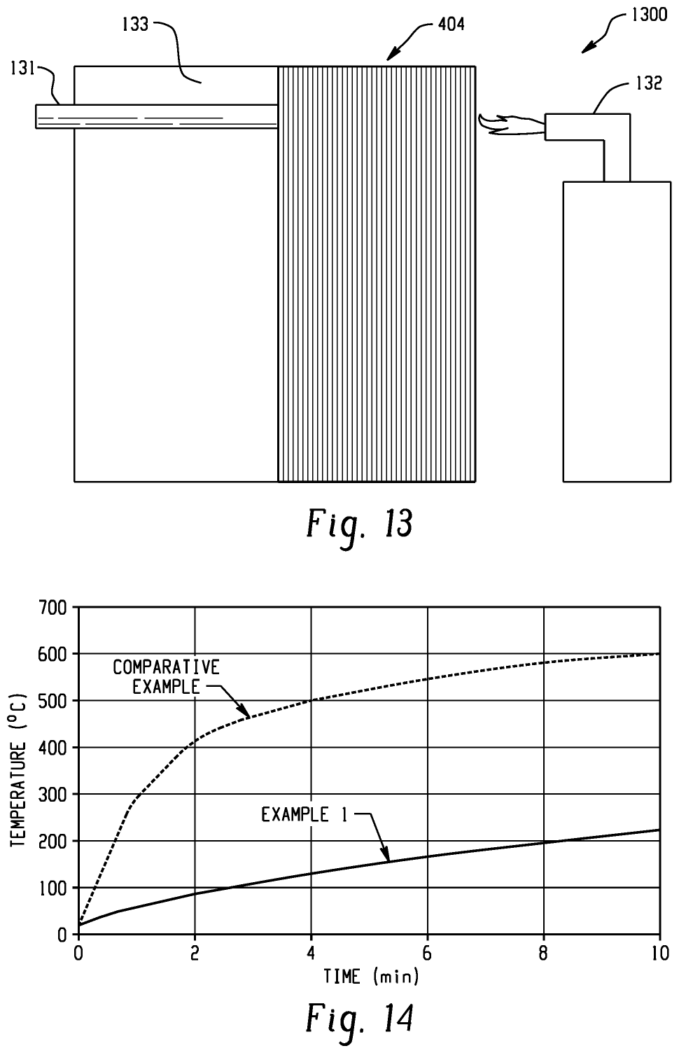

FIG. 13 illustrates the burn testing apparatus 1300. A hole was drilled through the pouch cell analog and a thermocouple probe 131 was inserted. A propane torch 132 was used to generate a 100 mm flame on the side of the sample 404 opposite the pouch cell analog 133. The propane torch 132 was placed 25 mm from the sample 404 surface. Temperature was recorded from the probe at 0.5, 1, 2, 3, 5, 7, and 10 minute intervals.

As shown in FIG. 14, after 10 minutes of direct flame from the propane torch, the Comparative Example reached a maximum temperature 604° C. Example 1 provided improved flame resistance as shown in FIG. 14. Example 1 reached a maximum temperature of 222° C. after 10 minutes of direct flame exposure, providing excellent flame resistance.

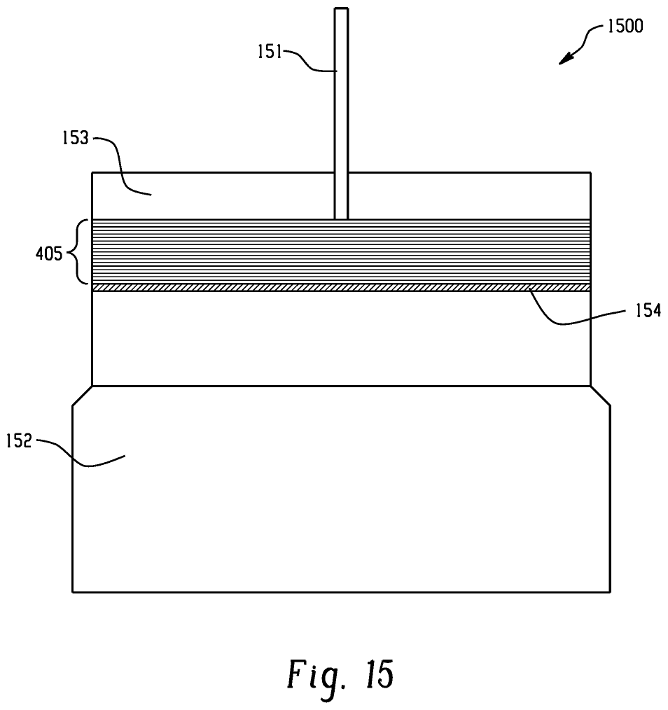

FIG. 15 illustrates a hot plate test apparatus 1500. A sample 405 is disposed opposite a pouch cell analog 153 (e.g., a 12.7 mm thick mica plate with a pouch cell film composite including 0.025 mm polyamide, 4-5 grams per square meter (g/m²) adhesive, 0.040 mm aluminum foil, 2-3 g/m² adhesive, 0.040 mm polypropylene). A through hole is drilled into the pouch cell analog 153 on a face opposite the sample 405 and a temperature sensor, e.g., thermocouple probe, 92 is inserted. Between the sample 405 and hot plate 152, a 0.001 inch (25.4 μm) aluminum foil 154 was placed to protect the hot plate 152 surface. The hot plate 152 is allowed to reach a temperature of 550° C. The pouch cell analog 153 and sample 405 are placed on the hot plate 152, with the sample 405 in closest proximity to the hot plate 152. A temperature sensor 151 is used to measure temperature at time intervals such as 0, 0.5, 1, 2, 3, 5, 7, and 10 minutes.

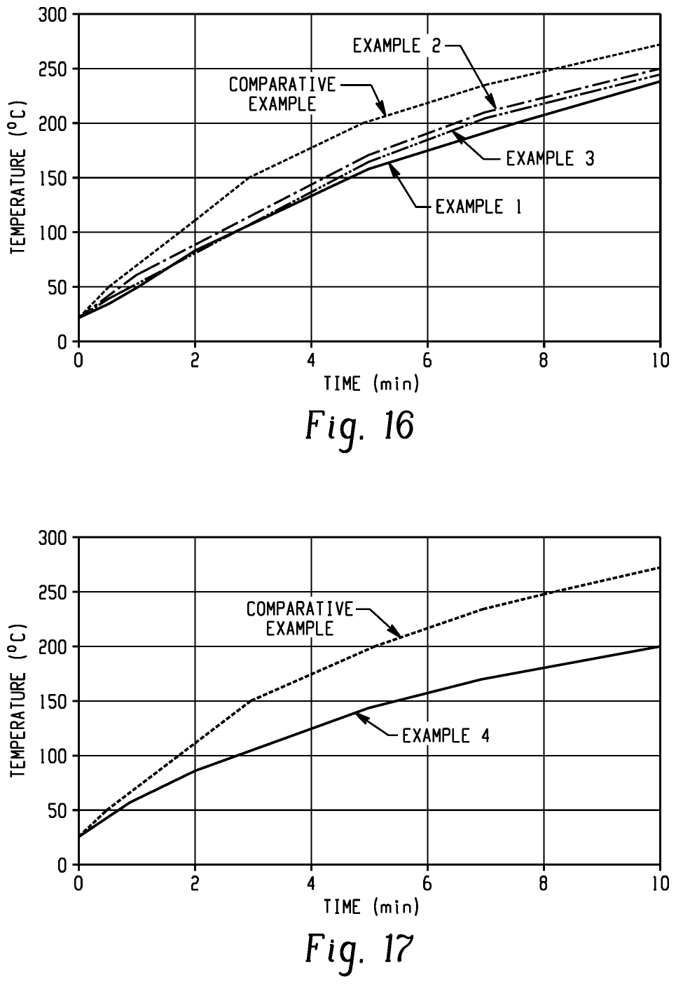

As shown in FIG. 16, Example 1 resulted in a delay of 100 seconds to reach 150° C. compared to the Comparative Example and a maximum temperature of 239° C. versus 273° C. for the Comparative Example. Examples 2 and 3 exhibit similar performance improvement over the Comparative Example. As shown in FIG. 17, Example 4 resulted in a delay of 142 seconds to reach 150° C. compared to the Comparative Example and a maximum temperature of 199° C.

Set forth below are non-limiting aspects of the present disclosure.

Aspect 1: An assembly for a battery, comprising a thermal management multilayer sheet disposed on a surface of an electrochemical cell, the thermal management multilayer sheet comprising a thermally-insulating layer, a first heat-spreading layer disposed on a first side of the thermally-insulating layer, and a second heat-spreading layer disposed on a second side of the thermally-insulating layer.

Aspect 2: The assembly for a battery of aspect 1, wherein the thermal management multilayer sheet is directly disposed on at least two surfaces of the electrochemical cell, preferably wherein the multilayer sheet is further disposed on the entirety of at least two, surfaces of the cell.

Aspect 3: The assembly for a battery of any of the foregoing aspects, wherein the electrochemical cell comprises a prismatic cell, a pouch cell, or a cylindrical cell, preferably a pouch cell.

Aspect 4: The assembly for a battery of any of the foregoing aspects, wherein the first and second heat-spreading layers each independently have a thickness of 5 to 1,000 micrometers.

Aspect 5: The assembly for a battery of any of the foregoing aspects, wherein the first and second heat-spreading layers each independently comprise copper, aluminum, silver, a copper alloy, an aluminum alloy, a silver alloy, boron nitride, aluminum nitride, silicon carbide, beryllium oxide, carbon fibers, carbon nanotubes, graphene, or graphite, or a combination thereof.

Aspect 6: The assembly for a battery of any of the foregoing aspects, wherein the thermally-insulating layer has a thickness of 50 to 15,000 micrometers, or 50 to 5,000 micrometers.

Aspect 7: The assembly for a battery of any of the foregoing aspects, wherein the thermally-insulating layer has a thermal conductivity of 0.01 to 1.0 W/m*K at 23° C., a heat of fusion of 70 to 350 J/g, or both, preferably wherein the thermally-insulating layer has a thermal conductivity of 0.01 to 0.09 W/m*K at 23° C., a heat of fusion of 70 to 350 J/g, or both.

Aspect 8: The assembly for a battery of any of the foregoing aspects, wherein the thermally-insulating layer comprises mica, vermiculite, a zeolite, an aerogel, a polymer foam, polymer fibers, a cork, a fiberglass, or a combination thereof, preferably wherein the thermally-insulating layer comprises a zeolite, an aerogel, a polymer foam, polymer fibers, a cork, a fiberglass, or a combination thereof.

Aspect 9: The assembly for a battery of any of the foregoing aspects, wherein the thermally-insulating layer is compressible, and has a compression set at 158° F. (70° C.) of less than 10%, measured according to ASTM D 3574-95 Test D.

Aspect 10: The assembly for a battery of aspect 9, wherein the thermally-insulating layer comprises a compressible elastomeric polymer, preferably wherein the compressible elastomeric polymer comprises vinyl acetate, a thermoplastic elastomer, an ethylene-propylene rubber, an ethylene-propylene-diene monomer rubber, or a combination thereof.

Aspect 11: The assembly for a battery of aspect 9, wherein the thermally-insulating layer comprises a compressible polymer foam, preferably a polyurethane foam or a silicone foam.

Aspect 12: The assembly for a battery of aspect 11, wherein the compressible polymer foam has a density of 80 to 481 kg/m³, a 25% compression force deflection of 351.5 to 70,307 kg/m², measured according to ASTM D 3574-95 Test C, and a compression set at 158° F. (70° C.) of less than 10%, preferably less than 5%, measured according to ASTM D 3574-95 Test D.

Aspect 13: The assembly for a battery of aspect 11 or 12, wherein the compressible polymer foam is in form of a layer having an uncompressed thickness 250 to 15,000 micrometers.

Aspect 14: The assembly for a battery of any one of the foregoing aspects, further comprising an adhesive layer disposed between the first heat-spreading layer and the thermally-insulating layer.

Aspect 15: The assembly for a battery of aspect 14, wherein the adhesive layer further comprises a particulate filler.

Aspect 16: The assembly for a battery of any one of the foregoing aspects, further comprising an integrity layer comprising a heat resistant reinforcement material disposed between the first heat-spreading layer and the thermally-insulating layer.

Aspect 17: The assembly for a battery of aspect 16, wherein the heat resistant reinforcement material comprises a woven or nonwoven mat comprising a high heat resistance polymer or glass.

Aspect 18: The assembly for a battery of aspect 16 or 17, wherein the integrity layer has a thickness of 20 to 600 micrometers.

Aspect 19: The assembly for a battery of any one of the foregoing aspects, wherein the thermal management multilayer sheet comprises, in order, the first heat-spreading layer; a first integrity layer; a first adhesive layer; the thermally-insulating layer; a second adhesive layer; a second integrity layer; and the second heat-spreading layer.

Aspect 20: The assembly for a battery of any one of the foregoing aspects, wherein the assembly comprises at least two electrochemical cells.

Aspect 21: A battery, comprising: the assembly for a battery of any one of aspects 1 to 20; and a housing at least partially enclosing the assembly for a battery.

Aspect 22: A thermal management multilayer sheet, comprising a first high temperature laminate adhered to a first side of a compressible thermally-insulating layer; and a second high temperature laminate adhered to a second opposite side of the compressible thermally-insulating layer, wherein the first high temperature laminate film comprises a first heat-spreading layer disposed on a first side of a first integrity layer, and a first adhesive layer disposed on an opposite second side of the first integrity layer, wherein the first adhesive layer adheres the first high temperature laminate film to the first side of the compressible thermally-insulating layer, and wherein the second high temperature laminate film comprises a second heat-spreading layer disposed on a first side of a second integrity layer, and a second adhesive layer disposed on an opposite second side of the second integrity layer, wherein the second adhesive layer adheres the second high temperature laminate film to the second side of the compressible thermally-insulating layer.

Aspect 23: An assembly for a battery, comprising the thermally-insulating multilayer sheet of aspect 22, disposed on an electrochemical cell.

Aspect 24: The assembly for a battery of aspect 23, wherein the assembly comprises at least two electrochemical cells.

Aspect 25: A battery, comprising: the assembly for a battery of any one of aspects 23 or 24; and a housing at least partially enclosing the assembly for a battery.

Aspect 26: A battery, comprising a thermal management multilayer sheet disposed adjacent at least two surfaces of an electrochemical cell, a cooling fin contacting a surface of the thermal management multilayer sheet opposite the electrochemical cell, and a cooling plate perpendicular to and in thermal contact with the cooling fin, the thermal management multilayer sheet comprising a first heat-spreading layer disposed on a first side of a thermally-insulating layer and a second heat-spreading layer disposed on a second side of the thermally-insulating layer.

Aspect 27: The battery of aspect 26, wherein the thermal management multilayer sheet covers two surfaces of the electrochemical cell.

Aspect 28: The battery of aspect 26 or 27, wherein the electrochemical cell comprises a prismatic cell, a pouch cell, or a cylindrical cell, preferably a pouch cell.

Aspect 29: The battery of any one of aspects 26-28, wherein the first and second heat-spreading layers each independently have a thickness of 0.0005 inches (12.7 micrometers) to 0.0200 inches (508 micrometers), preferably 0.001 inches (25.4 micrometers) to 0.005 inches (127 micrometers).

Aspect 30: The battery of any one of aspects 26-29, wherein the first and second heat-spreading layers each independently comprises copper, aluminum, an alloy of copper or aluminum, boron nitride, aluminum nitride, a nonwoven carbon nanotube sheet or tape, a carbon nanotube film, or a graphite film, preferably aluminum or an aluminum alloy.

Aspect 31: The battery of any one of aspects 26-30, wherein the thermally-insulating layer has a thickness of 0.002 inches (51 micrometers) to 0.039 inches (991 micrometers), preferably 0.006 inches (152 micrometers) to 0.020 inches (508 micrometers).

Aspect 32: The battery of any one of aspects 26-31, wherein the thermally-insulating layer has a thermal conductivity of 0.01 to 0.09 W/m*K at 23° C., a heat of fusion of 70 to 350 J/g, or both.

Aspect 33: The battery of any one of aspects 26-32, wherein the thermally-insulating layer comprises an aerogel, mica, a foam such as a polyurethane or silicone foam, a cork, or a fiberglass.

Aspect 34: The battery of any one of aspects 26-33, wherein the thermally-insulating layer further comprises a filler.

Aspect 35: The battery of any one of aspects 26-34, wherein the cooling fin comprises coolant channels.

Aspect 36: The battery of any one of aspects 26-35, further comprising a pressure pad, wherein the pressure pad comprises a polyurethane foam, or a silicone foam.

The compositions, methods, and articles described herein can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

The terms “a” and “an” do not denote a limitation of quantity, but rather denote the presence of at least one of the referenced item. The term “or” means “and/or” unless clearly indicated otherwise by context. Reference throughout the specification to “an aspect”, “another aspect”, and so forth, means that a particular element (e.g., feature, structure, step, or characteristic) described in connection with the aspect is included in at least an aspect described herein, and may or may not be present in other aspects. In addition, it is to be understood that the described elements can be combined in any suitable manner in the various aspects.

When an element such as a layer, film (including the thermally-insulating multilayer film), region, or substrate is referred to as being “on” another element, it is adjacent the other element, and can be directly on the other element or intervening elements can also be present. In contrast, when an element is referred to as being “directly on” another element, there are no intervening elements present. Further when an element such as a layer, film (including the thermally-insulating multilayer film), region, or substrate is referred to as being “on” or “directly on” another element, all or a portion of the element can be adjacent all or a portion of the other element.

Unless specified to the contrary herein, all test standards are the most recent standard in effect as of the filing date of this application, or, if priority is claimed, the filing date of the earliest priority application in which the test standard appears.

The endpoints of all ranges directed to the same component or property are inclusive of the endpoints, are independently combinable, and include all intermediate points and ranges. The terms “first,” “second,” and the like, “primary,” “secondary,” and the like, as used herein do not denote any order, quantity, or importance, but rather are used to distinguish one element from another. The term “combination thereof” or “at least one of” means that the list is inclusive of each element individually, as well as combinations of two or more elements of the list, and combinations of at least one element of the list with like elements not named. Also, the term “combination” is inclusive of blends, mixtures, alloys, reaction products, and the like.

Unless defined otherwise, technical and scientific terms used herein have the same meaning as is commonly understood by one of skill in the art to which this disclosure belongs.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

In the drawings, the widths and thicknesses of layers and regions are exaggerated for clarity of the specification and convenience of explanation. Like reference numerals in the drawings denote like elements.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

While particular aspects have been described, alternatives, modifications, variations, improvements, and substantial equivalents that are or can be presently unforeseen can arise to applicants or others skilled in the art. Accordingly, the appended claims as filed and as they can be amended are intended to embrace all such alternatives, modifications variations, improvements, and substantial equivalents.

What is claimed is:

1. An assembly for a battery, comprising
a thermal management multilayer sheet disposed on a surface of an electrochemical cell,
the thermal management multilayer sheet comprising
a thermally-insulating layer,
a first heat-spreading layer disposed on a first side of the thermally-insulating layer, and
a second heat-spreading layer disposed on a second side of the thermally-insulating layer.

2. The assembly for a battery of claim 1, wherein the thermal management multilayer sheet is disposed on at least two surfaces of the electrochemical cell.

3. The assembly for a battery of claim 1, wherein the electrochemical cell comprises a prismatic cell, a pouch cell, or a cylindrical cell.

4. The assembly for a battery of claim 1, wherein the first and second heat-spreading layers each independently have a thickness of 5 to 1,000 micrometers.

5. The assembly for a battery of any claim 1, wherein the first and second heat-spreading layers each independently comprise copper, aluminum, silver, a copper alloy, an aluminum alloy, a silver alloy, boron nitride, aluminum nitride, silicon carbide, beryllium oxide, carbon fibers, carbon nanotubes, graphene, graphite, or a combination thereof.

6. The assembly for a battery of claim 1, wherein the thermally-insulating layer has a thickness of 50 to 15,000 micrometers.

7. The assembly for a battery of claim 1, wherein the thermally-insulating layer has a thermal conductivity of 0.01 to 1.0 W/m*K at 23° C., a heat of fusion of 70 to 350 J/g, or both.

8. The assembly for a battery of claim 1, wherein the thermally-insulating layer comprises mica, vermiculite, a zeolite, an aerogel, a polymer foam, polymer fibers, a cork, a fiberglass, or a combination thereof.

9. The assembly for a battery of claim 1, wherein the thermally-insulating layer is compressible, and has a compression set at 158° F. (70° C.) of less than 10%, measured according to ASTM D 3574-95 Test D.

10. The assembly for a battery of claim 9, wherein the thermally-insulating layer comprises a compressible elastomeric polymer.

11. The assembly for a battery of claim 9, wherein the thermally-insulating layer comprises a compressible polymer foam.

12. The assembly for a battery of claim 11, wherein the compressible polymer foam has a density of 80 to 481 kg/m³, a 25% compression force deflection of 351.5 to 70,307 kg/m², measured according to ASTM D 3574-95 Test C, and a compression set at 158° F. (70° C.) of less than 10%.

13. The assembly for a battery of claim 11, wherein the compressible polymer foam is in the form of a layer having an uncompressed thickness 250 to 15,000 micrometers.

14. The assembly for a battery of claim 1, further comprising an adhesive layer disposed between the first heat-spreading layer and the thermally-insulating layer.

15. The assembly for a battery of claim 14, wherein the adhesive layer further comprises a particulate filler.

16. The assembly for a battery of claim 1, further comprising an integrity layer comprising a heat resistant reinforcement material disposed between the first heat-spreading layer and the thermally-insulating layer.

17. The assembly for a battery of claim 16, wherein the heat resistant reinforcement material comprises a woven or nonwoven mat comprising a high heat resistance polymer or glass.

18. The assembly for a battery of claim 16, wherein the integrity layer has a thickness of 20 to 600 micrometers.

19. The assembly for a battery of claim 1, wherein the thermal management multilayer sheet comprises, in order,
the first heat-spreading layer;
a first integrity layer;
a first adhesive layer;
the thermally-insulating layer;
a second adhesive layer;
a second integrity layer; and
the second heat-spreading layer.

20. The assembly for a battery of claim 1, wherein the assembly comprises at least two electrochemical cells.

21. A battery, comprising:
the assembly for a battery of claim 1; and
a housing at least partially enclosing the assembly for a battery.

22. A thermal management multilayer sheet, comprising
a first high temperature laminate adhered to a first side of a compressible thermally-insulating layer; and
a second high temperature laminate adhered to a second opposite side of the compressible thermally-insulating layer,
wherein the first high temperature laminate film comprises
a first heat-spreading layer disposed on a first side of a first integrity layer, and
a first adhesive layer disposed on an opposite second side of the first integrity layer, wherein the first adhesive layer adheres the first high temperature laminate film to the first side of the compressible thermally-insulating layer, and
wherein the second high temperature laminate film comprises
a second heat-spreading layer disposed on a first side of a second integrity layer, and
a second adhesive layer disposed on an opposite second side of the second integrity layer, wherein the second adhesive layer adheres the second high temperature laminate film to the second side of the compressible thermally-insulating layer.

23. An assembly for a battery, comprising
the thermally-insulating multilayer sheet of claim 22, disposed on an electrochemical cell.

24. The assembly for a battery of claim 23, wherein the assembly comprises
at least two electrochemical cells.

25. A battery, comprising:
the assembly for a battery of any one of claim 23; and
a housing at least partially enclosing the assembly for a battery.
